(19) United States
(12) Patent Application Publication
(10) Pub. No.: US 2003/0023692 A1
(43) Pub. Date: Jan. 30, 2003

(54) Electronic message delivery system, electronic message delivery managment server, and recording medium in which electronic message delivery management program is recorded

(75) Inventor: Jun Moroo, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/987,889

(22) Filed: Nov. 16, 2001

(30) Foreign Application Priority Data
Jul. 27, 2001 (JP) 2001-227383

(51) Int. Cl. G06F 15/16

(52) U.S. Cl. 709/206

(57) ABSTRACT

An apparatus is provided which allows a user, while surely rejecting unwanted electric messages with a white list, to browse the rejected messages so as to check their contents. Electric messages from persons unlisted on the permitted-sender list are accumulated in the message holder, and upon receipt of a browsing request from a user terminal, the messages stored in the message holder are permitted to be browsed by the user. While the user is browsing the messages on the user terminal, a link is established between the sender information and the permitted-sender list, and the sender information is added/registered to the permitted-sender list, in response to the user selecting the sender information of the electronic message on the user terminal. This apparatus is applicable to a system for electronically delivering electronic mail such as e-mail and voice mail that is sent directly to mobile telephones.

### BACKGROUND OF THE INVENTION

1. Field of the Invention

The present invention relates to a system for delivering electronic messages (in the following description, an “electronic message” is a message electronically sent out on a communication network, such as e-mail and voice mail, which is directly sent to a mobile telephone). The invention also relates to a server and a program for managing the delivering of the electric messages and to a recording medium in which the program is recorded.

2. Description of the Related Art

The recent widespread use of the Internet is making the use of e-mail prevalent in more companies and associations, and also among individuals. Mobile telephones are also becoming increasingly popular, and now there is nearly one mobile telephone to every person in Japan.

Accompanying this popularity is the problem of unsolicited commercial e-mail advertisements (“spam”) A great amount of e-mail is directed to a large number of users without their permission because the cost for sending e-mail is lower than that for sending postal mail. Unlike postal direct mail, the cost for communications required by spam is often imposed on the users, even though most of such spam is useless to the user.

For the purpose of resolving this problem, recent e-mail delivery software has been equipped with a function for rejecting e-mail directed from particular addresses. Even using this function, however, it is still impossible to reject spam completely. Accordingly, carrying such a function a step further has led to the development of a so-called “white list”, in which only e-mail from particular addresses is accepted. Further, there has been provided another method where e-mail containing particular character strings or titles is regarded as unwanted spam and is then refused (a method of finding and rejecting spam with use of e-mail patterns). At that time, the above-mentioned particular character strings clearly indicating direct mail would be previously set by a provider of the e-mail delivery system: a good example of such a character string might be, “a chance to make a bit of money.”

Using mailing lists, e-mail can be automatically delivered to multiple users. With such a mailing list, messages sent to a particular address are automatically delivered to other addresses that have been previously set. Various types of mailing lists are in use: type (a) in which only registered members are able to post messages; type (b) in which anybody is able to post messages at will; and type (c) in which only moderators, or a limited number of special members, are able to post messages. In the above type (a) mailing list, if a message is posted by someone who is not a member, an administrator of the mailing list is notified that a message has arrived from an unregistered person. Further, in such mailing lists, posted messages are often publicized on a Web-base.

With a method of rejecting any e-mail from particular addresses, however, all e-mail directed from particular domains is regarded as unwanted mail, making it impossible to obtain any e-mail which has been sent from those domains. Deleting/rejecting all the unwanted e-mail at once would bring about an advantage of shutting out spam, but it would also cause a disadvantage in that proper e-mail from the domains could not be received, even without being notified of the arrival of proper e-mail.

With the method of using mail patterns in finding and rejecting spam, even proper e-mail would not be accepted as it would be accidentally regarded as spam.

Further, with the white list method, all e-mail from persons who are not on the list is rejected. In that case, however, if a person whose e-mail address is registered on the list has stopped using that address and begun to use a new e-mail address without informing the user (addressee/recipient), that person's mail would no longer be accepted. In other words, once the e-mail address of any proper sender who is on a white list is changed to another, every e-mail directed from the new address would no longer be accepted because the address is not registered on the list as a permitted (authorized) sender's e-mail address, thereby making it impossible for the user to receive the sent-out e-mail.

Accordingly, using the above-mentioned function of a mailing list, it is also possible to reject e-mail directed from any unregistered address in the following manner. Assuming that a recipient is a mailing list administrator, and that the destination of any personal e-mail that has been addressed to a specific address of the mailing list is the recipient (administrator) himself/herself, the addresses of permitted senders, whose e-mail the recipient would like to accept, are then listed as members of the mailing list, so that every e-mail directed from an address that is not listed as a member of the mailing list is rejected as unwanted e-mail. At that time, the e-mail (rejected mail) that has been sent from an address that is not registered as a member would be re-delivered to the administrator of the mailing list, or the recipient himself/herself, as mail directed from an unregistered person.

In such a case, where a mailing list is employed to realize both an e-mail rejection/permission function and an e-mail re-delivery function, however, there still remains the following problem: the use of an ordinary mailing list program would make it difficult for the recipient (mailing list administrator) to add additional e-mail addresses of new members to the mailing list. This is because such an ordinary mailing list program is of course produced without taking into consideration the above-mentioned e-mail rejection/permission function or e-mail re-delivery function.

### SUMMARY OF THE INVENTION

With the foregoing problems in view, it is one object of the present invention to make it possible, while surely rejecting unwanted electronic messages with a white list, to browse the rejected messages so as to check their contents. Another object of the invention is to provide an easy way to register a sender's address of a once rejected electronic message in the white list.

In order to accomplish the above objects, according to the present invention, there is provided an electronic message delivery system comprising: (a) a terminal from which a user is able to browse electronic messages, electronically sent out on a communications network and addressed to the user; (b) a permitted-sender list (white list) in which permitted-sender information about a permitted sender, whose every electronic message is permitted to be received by the user on the terminal, is registered; (c) sender information obtaining means for obtaining sender information from an individual electronic message addressed to the user; (d) checking means for checking as to whether or not the sender information, which has been obtained by the sender information obtaining means, of the last-named individual electronic message is identical with the permitted-sender information registered in the permitted-sender list; (e) delivering means for delivering the last-named electronic message, which contains the last-named sender information registered in the permitted-sender list, to the user if the result of the checking by the checking means is positive; (f) a message holder for temporarily holding every electronic message from any sender so as to be browsed by the user from the terminal; (g) storing control means for storing the last-named electronic message into the message holder if the result of the checking by the checking means is negative; (h) browsing control means for allowing the individual electronic messages, which have been temporarily held in the message holder, to be browsed by the user from the terminal upon a browsing request of the user from the terminal; (i) link setting means for setting a link between the sender information of an individual electronic message, which has been temporarily held in the message holder, and the permitted-sender list while the user is browsing the last-named individual electronic message from the terminal; and (j) registering means for registering the sender information of an electronic message in the permitted-sender list when the sender of the last-named electronic message is selected as a newly permitted sender by the user from the terminal. As one preferred feature, an electronic message delivery system further comprises a notifying means for notifying the user that an electronic message has been held in the message holder, if the message holder holds the last-specified electronic message therein.

As one generic feature, there is provided an electronic message delivery management server for managing the delivering of electronic messages, electronically sent out on a communications network and addressed to a user. The server comprises: a permitted-sender list; sender information obtaining means; checking means; delivering means; a message holder; storing control means; browsing control means; link setting means; and registering means, each of which has already been described above.

As another generic feature, there is provided a recording medium in which an electronic message delivery management program for a computer to manage the delivering of electronic messages, electronically sent out on a communications network and addressed to a user, is recorded, wherein the program instructs the computer to function as the following: sender information obtaining means; checking means; delivering means; a message holder; storing control means; browsing control means; link setting means; and registering means, each of which has already been described above.

The electronic message delivery system, the electronic message delivery management server, and the recording medium in which an electronic message delivery management program is recorded, according to the present invention, guarantee the following advantageous results. While using a white list to reject unwanted electronic messages with certainty, it is possible for a user to browse the rejected messages so as to check their contents. In other words, it is possible to surely reject unwanted electronic messages and also to browse the rejected messages, with a simple construction and no increased cost. Moreover, it is merely necessary for a user to select (say, to click) a sender's address on a user terminal, while browsing a rejected electronic message thereon, so as to enter the sender's address of the rejected message in a permitted-sender list (white list).

Further, in cases where any unwanted electronic message is stored in a message holder, the user is automatically notified by a notifying means, thus making it possible for the user to recognize that an unwanted electronic message, which has been rejected, is being stored in the message holder, thereby significantly improving the user friendliness.

At that time, the notifying means automatically notifies the user of information relevant to the unwanted electronic messages stored in a message holder at prescribed time intervals, so that the notification can be carried out for all the unwanted messages in the message holder at once. As a result, it is no longer necessary to perform the notification every time an unwanted electronic message is stored in the message holder, thereby freeing the user from annoying repetitious confirmation of the notification, even with so many unwanted incoming messages.

Other objects and further features of the present invention will be apparent from the following detailed description when read in conjunction with the accompanying drawings.

### BRIEF DESCRIPTION OF THE DRAWINGS

FIG. 1 is a block diagram schematically showing a construction of an electronic message delivery system of one embodiment of the present invention;

FIG. 2 is a block diagram showing a functional construction of an electronic message delivery management server of one embodiment of the present invention; and

FIG. 3 through FIG. 6 are flowcharts each indicating operations of one embodiment of the present invention.

### DESCRIPTION OF THE PREFERRED EMBODIMENT(S)

One preferred embodiment of the present invention will now be described with reference to relevant accompanying drawings.

[1] Description of One Embodiment:

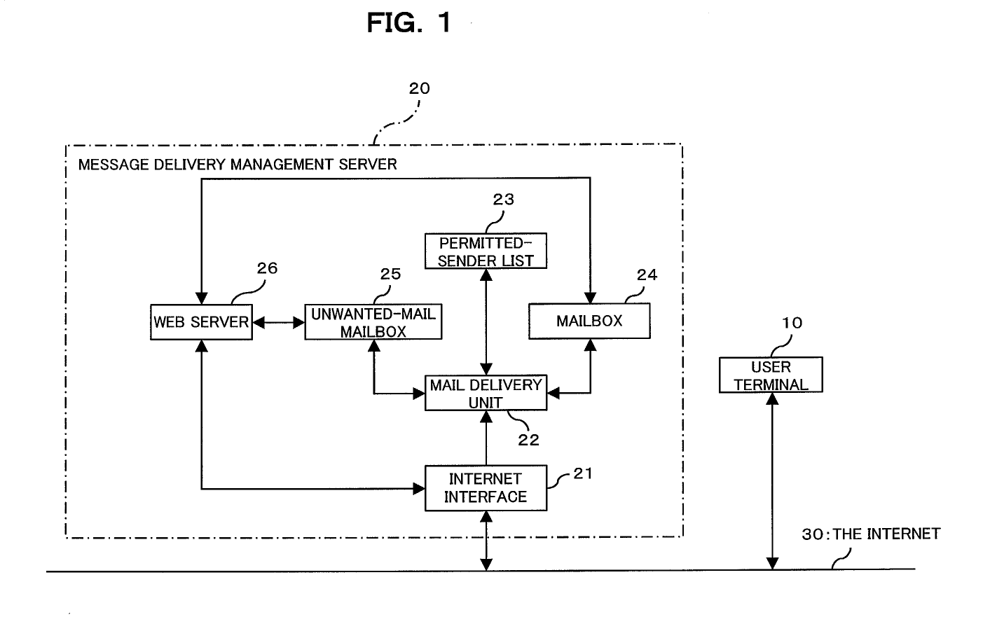

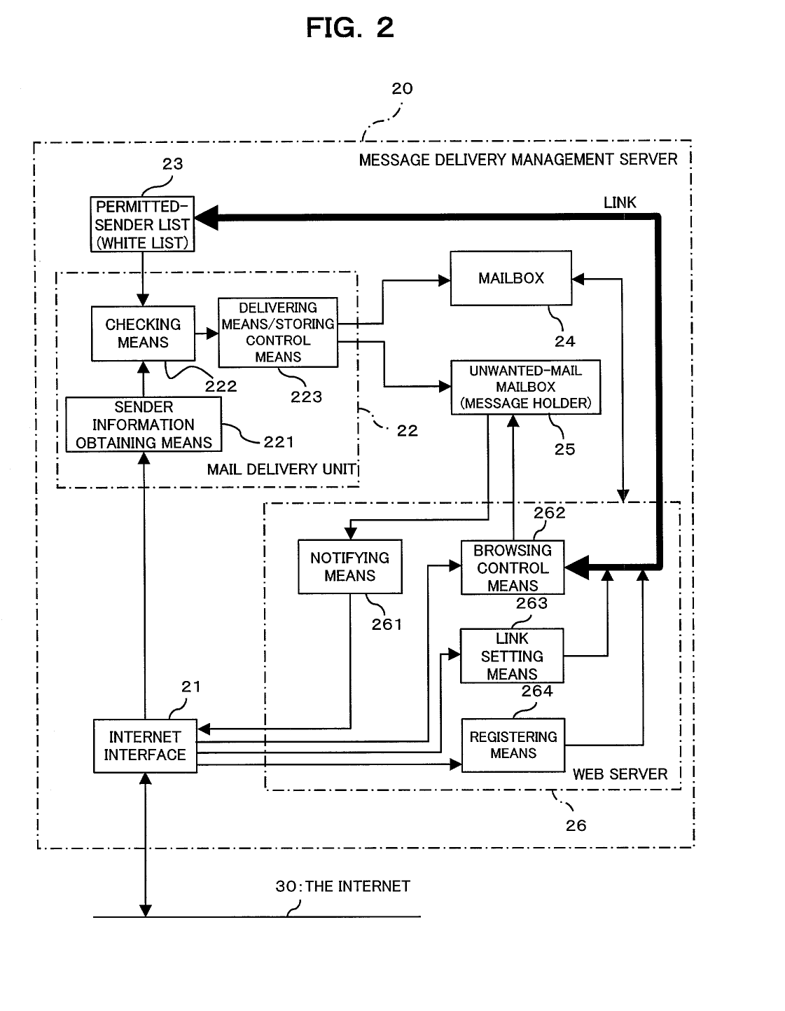

FIG. 1 depicts a construction of an electronic message (in this description, an “electronic message” is a message electronically sent out on a communications network, and includes various types of electronic messages such as e-mail, voice mail, and others; hereinafter also called simply “message”) delivery system of one embodiment of the present invention, and FIG. 2 depicts a functional construction of an electronic message delivery management server of one embodiment of the present invention.

Referring now to FIG. 1, an electronic message delivery system of the present invention includes user terminal 10, electronic message delivery managing server 20, and the Internet 30. Electronic message delivery managing server 20 is communicably interconnected with one or more user terminals 10 via the Internet 30.

User terminal 10, which is realized in use by, for example, a personal computer or an internet-accessible mobile telephone, has the functions of transmitting/receiving and browsing messages (e-mail, in this example: hereinafter also called simply “mail”) electronically delivered on the Internet 30.

Electronic message delivery managing server 20, which is realized in use by a computer system that is formed of a computer (CPU) and various databases, manages the delivering of messages, electronically delivered to the user. Electronic message delivery managing server 20 includes Internet interface 21, mail delivery unit 22, permitted-sender list 23, mailbox 24, unwanted-mail mailbox 25, and Web server 26.

Here, Internet interface 21 functions as an interface between the Internet 30 and the above-mentioned computer.

Mail delivery unit 22 delivers mail having a predetermined domain name, which mail has been received via the Internet 30 and Internet interface 21, to mailbox 24 or unwanted-mail mailbox 25 and stores the mail therein. As shown in FIG. 2, mail delivery unit 22 includes sender information obtaining means 221, checking means 222, and delivering means/storing control means 223.

Permitted-sender list (white list) 23 registers permitted-sender information (addresser information; for example, senders' mail addresses) about permitted senders, from whom all mail messages are permitted to be received by a user on user terminal 10. A user is able to change what is listed on permitted-sender list 23 via a Web browser, with an editor on user terminal 10. That is, the user is able to register, remove, and appropriately change the permitted-sender information in permitted-sender list 23, on terminal 10 via the Internet 30.

Mailbox 24 receives mail messages that are addressed to the user (user terminal) from anyone (senders/addressers) who is registered in permitted-sender list 23. The mail messages are delivered from mail delivery unit 22 to mailbox 24 and accumulated therein, so as to be temporarily stored as permitted senders' mail. The mail messages stored in mailbox 24 are received on user terminal 10 according to any mail receiving procedure such as POP (Post Office Protocol) and IMAP (Internet Message Access Protocol).

Unwanted-mail mailbox (message holder) 25 receives mail messages that are addressed to the user (the user's terminal) from anyone who is unregistered in permitted-sender list 23. The mail messages are delivered from mail delivery unit 22 to unwanted-mail mailbox 25 and accumulated therein, so as to be temporarily stored as unwanted mail (mail messages highly likely to be unnecessary for the user). Such unwanted mail messages are stored in unwanted-mail mailbox 25 in such a manner that the user is able to browse the mail messages from user terminal 10 on Web server 26 via the Internet 30.

Web server 26, in response to a browsing request from user terminal 10, allows the user to browse the unwanted mail stored in unwanted-mail mailbox (message holder) 25, from user terminal 10 via the Internet 30. As shown in FIG. 2, Web server 26 has notifying means 261, browsing control means 262, link setting means 263, and registering means 264. Additionally, in response to a transfer request from user terminal 10, Web server 26 transfers the permitted senders mail stored in mailbox 24 to user terminal 10 via the Internet 30.

Accordingly, it is possible for the user to access electronic message delivery managing server 20 (Web server 26) from user terminal 10 via the Internet 30, thereby downloading the permitted senders' mail stored in mailbox 24, and it is also possible to browse the unwanted mail stored in unwanted-mail mailbox 25 from user terminal 10 on Web server 26. That is, using an ordinary Web mail system, the user is able to receive the unwanted mail stored in unwanted-mail mailbox 25, on user terminal 10.

Next, referring now to FIG. 2, a description will be made hereinbelow of a construction of electronic message delivery managing server 20 of the present embodiment. In particular, detailed descriptions will be made of mail delivery unit 22 and Web server 26.

Sender information obtaining means 221 of mail delivery unit 22, according to the present embodiment, obtains sender information (sender's mail address) from a mail message addressed to a user, which message has a predetermined domain name and is received via the Internet 30 and Internet interface 21.

Checking means 222 checks the sender information, which has been obtained by sender information obtaining means 221, against the permitted-sender information registered in the permitted-sender list 23.

If checking means 222 finds the sender information is included in permitted-sender list 23, delivering means/storing control means 223 stores the mail message addressed to the user in mailbox 24 as a permitted sender's mail message, in order to deliver the mail message to the user, thereby functioning as a delivering means. At that time, delivering means/storing control means 223 stores the permitted sender's mail in mailbox 24 in accordance with an ordinary mail delivery procedure.

Otherwise, if the sender information is found to be unregistered in permitted-sender list 23, delivering means/storing control means 223 stores the mail message addressed to the user in unwanted-mail mailbox 25 as unwanted mail, thereby functioning as a storing control means.

Notifying means 261 of Web server 26, according to the present embodiment, notifies a user (user terminal 10) that a message has been held in unwanted-mail mailbox 25, if any unwanted message is held in the unwanted-mail mailbox 25. At that time, notifying means 261 notifies by mail that a mail message has arrived from a person who is not listed on permitted-sender list 23, and also notifies the sender's information and the title of the mail message.

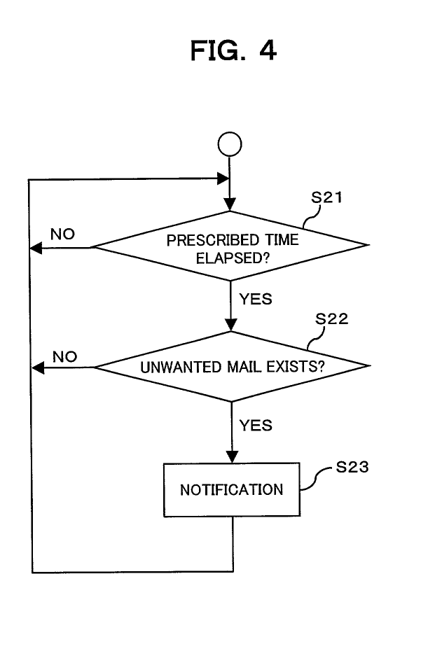

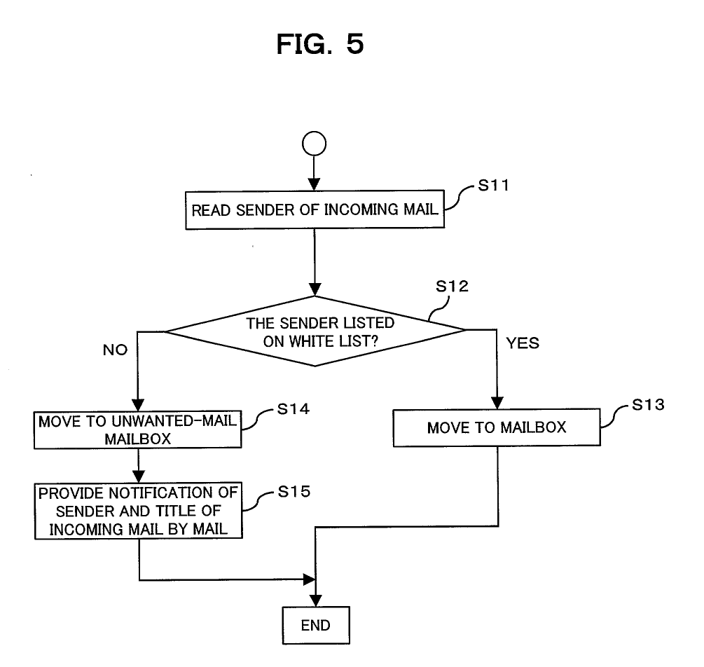

Such notification by notifying means 261 is made every time an unwanted mail is stored in unwanted-mail mailbox 25 (see FIG. 5), or is alternatively made at prescribed time intervals (once a day, for example), for all the unwanted mails stored in unwanted-mail mailbox 25 at one time (see FIG. 4). Otherwise, the notification may be made, when a predetermined number of mail messages accumulate in unwanted-mail mailbox 25, for all the unwanted mail messages at the same time.

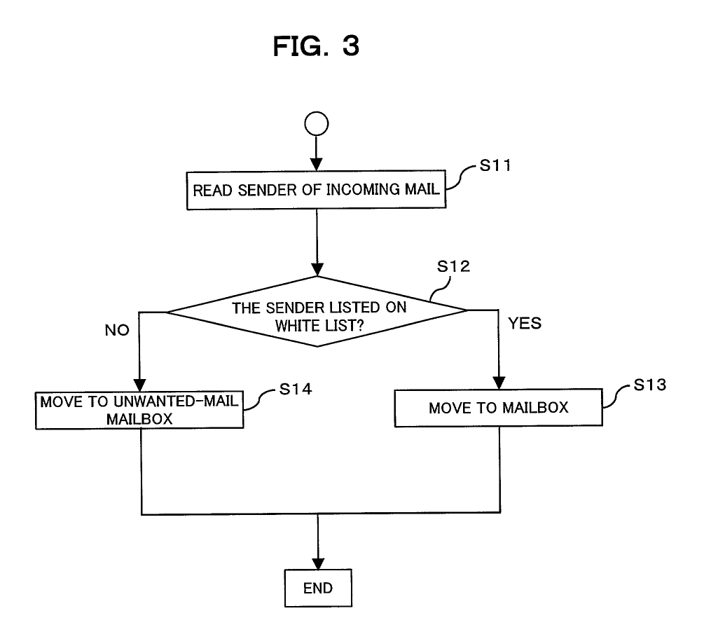

In this instance, without either activating notifying means 261 (or without providing notifying means 261 to Web server 26), or notifying a user (user terminal 10), from electronic message delivery managing server 20, of the arrival of any mail message from a person unlisted on permitted-sender list 23, the user may access electronic message delivery managing server 20 by himself/herself to check unwanted mail arrival (see FIG. 3).

Browsing control means 262 executes various controls to allow a user to browse unwanted mail messages, which have been temporarily held in unwanted-mail mailbox 25, in response to a browsing request of the user from the user terminal 10.

Link setting means 263 sets a link between the sender information of an unwanted mail message, which has been temporarily held in unwanted-mail mailbox 25, and permitted-sender list 23, while the user is browsing the unwanted mail message from the user terminal 10.

Registering means 264 registers the sender information of an unwanted mail message in permitted-sender list 23 when the sender of the unwanted mail message is selected (clicked), through a Web mail system, as a newly permitted sender by the user from user terminal 10.

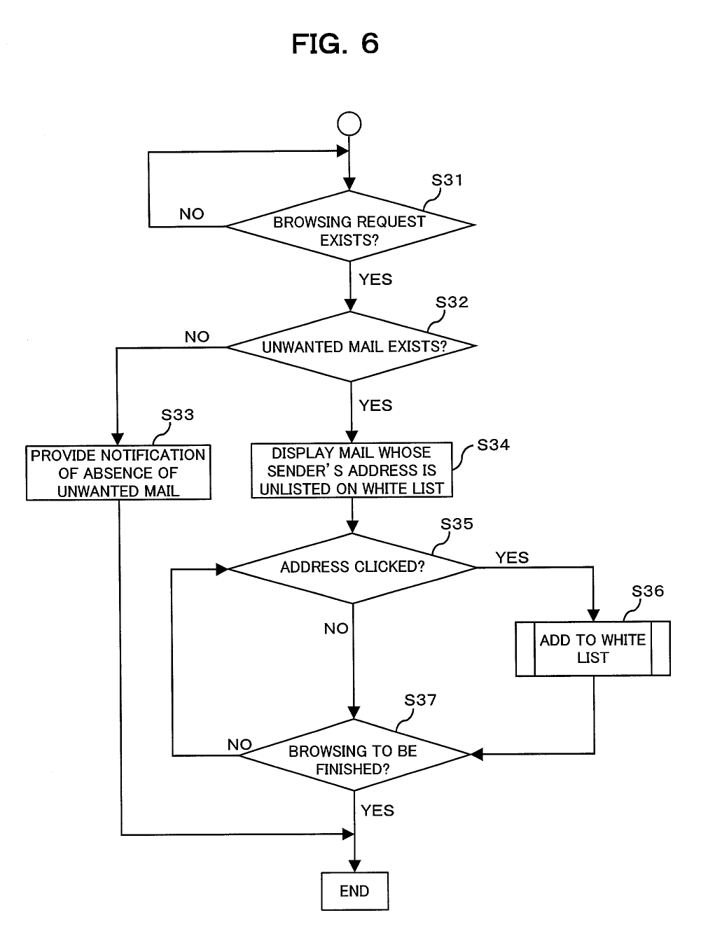

In summary, using the functions realized by browsing control means 262, link setting means 263, and registering means 264, it is possible for a user to add/register another piece of sender information to permitted-sender list 23 through a Web mail system. In this case, merely by clicking the sender information (a sender's address) shown on a display of user terminal 10, the user is allowed to add the sender's address to permitted-sender list 23 (see FIG. 6).

The above-described sender information obtaining means 221, checking means 222, delivering means/storing control means 223, notifying means 261, browsing control means 262, link setting means 263, and registering means 264 are realized by dedicated software (an electronic message delivery management program).

An electronic message delivery management program is provided in the form of being stored in a computer-readable recording medium such as a flexible disc and a CD-ROM. In the present embodiment, an electronic message delivery management program is previously stored in a ROM (Read Only Memory; not shown), which constitutes electronic message delivery managing server 20, and the electronic message delivery management program is then read out and executed by a CPU (computer; not shown), which also constitutes electronic message delivery managing server 20, thereby realizing the functions of the following: sender information obtaining means 221, checking means 222, delivering means/storing control means 223, notifying means 261, browsing control means 262, link setting means 263, and registering means 264.

The electronic message delivery management program may alternatively be recorded in a storage device (recording medium), such as a magnetic disc, an optical disc, and a magneto-optical disc, to be provided therefrom to a computer through a communication path.

The above-described permitted-sender list 23 mailbox 24, and unwanted-mail mailbox 25 are realized by a RAM (Random Access Memory; not shown) built in a computer that constitutes electronic message delivery managing server 20 or by a storage device (or external storage device) such as a hard disc.

Referring now to the flowcharts of FIG. 3 through FIG. 6, a description will now be given hereinbelow of an operation of the message delivery management system of the present embodiment.

First of all, making reference to FIG. 3 through FIG. 5, there is described a mail delivery process (an operation of mail delivery unit 22) which is carried out upon the arrival of a mail message at electronic message delivery managing server 20.

Referring now to the flowchart (steps S11 through S14) of FIG. 3, a mail delivery process with no using notifying means 261 (without activating or providing notifying means 261) will be described. An e-mail message sent out to a user (user terminal 10) on the Internet 30 reaches mail delivery unit 22 via Internet interface 21. The delivery is carried out in accordance with an ordinary mail delivery procedure. Once the mail arrives at mail delivery unit 22, sender information obtaining means 221 reads the sender information (addresser information, sender's mail address) of the mail (step S11).

Checking means 222 then checks whether or not the read-out sender information is listed on permitted-sender list (white list) 23 (step S12). If the check result is positive (YES route of step S12), delivering means/storing control means 223, according to an ordinary mail delivery procedure, delivers the mail to mailbox 24 to be accumulated therein as mail received from a permitted sender (step S13). The mail thus stored in mailbox 24 is received on user terminal 10 in accordance with a mail receiving procedure such as POP and IMAP.

Otherwise if the sender information is not listed on permitted-sender list 23 (NO route of step S12), delivering means/storing control means 223 delivers the mail to unwanted-mail mailbox 25 to be accumulated therein as unwanted mail (step S14). The mail thus stored in unwanted-mail mailbox 25 is browsed on user terminal 10 using an ordinary Web mail system.

Here, if notifying means 261 is not activated, or if notifying means 261 is not provided, a user, when he/she would like to obtain any information about the unwanted mail, accesses electronic message delivery managing server 20 from user terminal 10 to check the arrival of unwanted mail or the contents of the unwanted mail on Web server 26. At that time, since no notification is made to the user of the arrival of the unwanted mail, the user is never able to notice the unwanted mail unless the user accesses electronic message delivery managing server 20.

Notifying means 261 might be activated therefore in accordance with the flowchart (steps S21 through S23) of FIG. 4. Precisely, it is evaluated whether or not a prescribed time period (say, 24 hours) has elapsed (step S21), and then if the evaluation result is positive (YES route of step S21), it is evaluated whether or not any unwanted mail is being stored in unwanted-mail mailbox 25 (step S22).

If the evaluation result is positive (YES route of step S22), notifying means 261 notifies the user (user terminal 10) by mail that unwanted mail has arrived from persons who are not on permitted-sender list 23, and is stored in unwanted-mail mailbox 25, and also notifies the sender information and the titles of the unwanted mail (step S23).

In this manner, the notification is made at prescribed time intervals (say, once a day) for all the unwanted mail in unwanted-mail mailbox 25 at the same time. In this instance, instead of measuring time, the number of unwanted mail messages accumulated in unwanted-mail mailbox 25 may be counted. In that case, at the time when the number reaches a prescribed value, the notification in step S23 is carried out.

Alternatively, a mail delivery process may be carried out, following the flowchart (steps S11 through S15) of FIG. 5. Precisely, in the process of FIG. 5, after completion of step S14 of FIG. 3, the notification in step S15 is executed immediately. Thereby, when every unwanted mail is stored in unwanted-mail mailbox 25, notifying means 261 notifies a user (user terminal 10) by mail that a mail message has arrived from a person who is not listed on permitted-sender list 23, and also notifies the sender's information and the title of the mail message. In FIG. 5, in the steps given the same step numbers (S11 through S14) as in FIG. 3, the same or approximately the same processes as those described with reference to FIG. 3 are performed, so their detailed description is omitted here.

Referring now to the flowchart (steps S31 through S37) of FIG. 6, a description will be made hereinbelow of a process (an operation of Web server 26) that is performed upon receipt of a request for browsing unwanted mail from a user (user terminal 10).

As shown in FIG. 6, when the unwanted mail browsing request is received from a user (user terminal 10) on Web server 26 (YES route of step S31), it is evaluated whether or not unwanted-mail mailbox 25 is storing any unwanted mail addressed to the user, who has issued the browsing request (step S32). If the evaluation result is negative (NO route of step S32), the user (user terminal 10) is notified as such (step S33), and the process is completed.

Otherwise if the evaluation result is positive (YES route of step S32), browsing control means 262 reads out the unwanted mail from unwanted-mail mailbox 25 to show on a display of user terminal 10 (step S34), thereby making it possible for the user to browse the unwanted mail. At that time, as described above, a link has already been established by link setting means 263 between the sender information (sender's mail address) of the unwanted mail and permitted-sender list 23.

Web server 26 then evaluates whether or not the sender's address shown on the display has been clicked, while the user is browsing the unwanted mail (step S35). If the evaluation result is positive (YES route of step S35), registering means 264 adds/registers the sender's address thus having been clicked to permitted-sender list 23 (step S36).

Instead of using a link which has been set by Web server 26, as described above, it is possible for a user to write a sender's address in permitted-sender list 23 with an editor, from user terminal 10 through a Web browser, so that an additional sender's address is registered in permitted-sender list 23.

Otherwise, if the evaluation result is negative (NO route of step S35), or after completion of adding the sender's address in step S36, it is evaluated whether or not the user's browsing is completed (step S37). If the evaluation result is negative (NO route of step S37), the process returns to step S35 and similar steps to those described above are repeated. Otherwise if the evaluation result is positive (YES route of step S37), the process ends.

In this manner, according to the electronic message delivery system (electronic message delivery managing server 20) of one embodiment of the present invention, mail messages from persons who are not on permitted-sender list 23 are accumulated in unwanted-mail mailbox 25 of electronic message delivery managing server 20, and it is possible for a user, with a WWW browser, to browse such mail messages and to add and remove some sender information in permitted-sender list 23.

Accordingly, while using a white list to surely reject unwanted mail, it is still possible for a user to browse the rejected mail on Web server 26 so as to check the contents of the rejected mail.

In other words, it is both possible to surely reject unwanted mail and to browse the rejected mail, with a simple construction and with no increased cost. Moreover, it is merely necessary for a user to select (say, to click) a sender's address on user terminal 10, while browsing the rejected mail thereon, so as to register the sender's address of the rejected mail in permitted-sender list 23.

Furthermore, in cases where any unwanted mail is stored in unwanted-mail mailbox 25, notifying means 261 automatically notifies a user of the situation, thus making it possible for the user to recognize that unwanted mail, which has been rejected, is stored in unwanted-mail mailbox 25, thereby significantly improving the user friendliness.

At that time, notifying means 261 automatically notifies the user (user terminal 10) of the information relevant to the unwanted mail stored in unwanted-mail mailbox 25 at prescribed time intervals, so that notification can be performed for all the unwanted mail messages in unwanted-mail mailbox 25 at the same time. As a result, it is no longer necessary to carry out notification every time an unwanted mail message is stored in unwanted-mail mailbox 25, thereby freeing the user from annoying repetitious confirmation of the notification, even with so many incoming unwanted mail messages.

[2] Other Modifications:

The present invention should by no means be limited to the above-illustrated embodiments, and various changes or modifications may be suggested without departing from the gist of the invention.

For example, in the above embodiment, an electronic message, electronically sent out on a communication network, was e-mail, and a system and a server of the present invention would also be applicable in cases where the electronic message is voice mail, say, direct-mail by voice which is sent directly to a mobile telephone, and similar effects and profits to those in the above-described embodiment can be also attained.

Further, unwanted mail stored in unwanted-mail mailbox 25 may be removed by a user, as in an ordinary Web mail system, or it may alternatively be deleted automatically, after a prescribed time period has elapsed, or depending upon the capacity of a mailbox.

Still further, though mail messages from persons who are listed on permitted-sender list 23 are accumulated in mailbox 24 to wait for the user's accessing, the mail messages may alternatively be directed to a predetermined address.

Furthermore, a widely used e-mail delivery program (say, sendmail) is capable of activating a filer program for each user ID. It is of course possible to employ the function of the present invention in such a mail delivery program so as to serve as the filter program.

What is claimed is:

1. An electronic message delivery system comprising:
(a) a terminal from which a user is able to browse electronic messages, electronically sent out on a communications network and addressed to the user;
(b) a permitted-sender list in which permitted-sender information about a permitted sender, whose every electronic message is permitted to be received by the user on said terminal, is registered;
(c) sender information obtaining means for obtaining sender information from an individual electronic message addressed to the user;
(d) checking means for checking as to whether or not said sender information, which has been obtained by said sender information obtaining means, of the last-named individual electronic message is identical with said permitted-sender information registered in said permitted-sender list;
(e) delivering means for delivering said last-named electronic message, which contains said last-named sender information registered in said permitted-sender list, to the user if the result of the checking by said checking means is positive;
(f) a message holder for temporarily holding every electronic message from any sender so as to be browsed by the user from said terminal;
(g) storing control means for storing the last-named electronic message into said message holder if the result of the checking by said checking means is negative;
(h) browsing control means for allowing the individual electronic messages, which have been temporarily held in said message holder, to be browsed by the user from said terminal upon a browsing request of the user from said terminal;
(i) link setting means for setting a link between said sender information of an individual electronic message, which has been temporarily held in said message holder, and said permitted-sender list while the user is browsing the last-named individual electronic message from said terminal; and
(j) registering means for registering said sender information of an electronic message in said permitted-sender list when the sender of the last-named electronic message is selected as a newly permitted sender by the user from said terminal.

2. An electronic message delivery system according to claim 1, further comprising notifying means for notifying the user that an electronic message has been held in said message holder, if said message holder holds the last-named electronic message therein.

3. An electronic message delivery system according to claim 2, wherein said notifying means performs the notification of said last-named electronic message held in said message holder, at prescribed time intervals.

4. An electronic message delivery system according to claim 1, wherein said electronic message is an e-mail.

5. An electronic message delivery system according to claim 2, wherein said electronic message is an e-mail.

6. An electronic message delivery system according to claim 3, wherein said electronic message is an e-mail.

7. An electronic message delivery system according to claim 1, wherein said electronic message is a voice mail.

8. An electronic message delivery system according to claim 2, wherein said electronic message is a voice mail.

9. An electronic message delivery system according to claim 3, wherein said electronic message is a voice mail.

10. An electronic message delivery management server for managing the delivering of electronic messages, electronically sent out on a communications network and addressed to a user, comprising:
(a) a permitted-sender list in which permitted-sender information about a permitted sender, whose every electronic message is permitted to be received by the user on a terminal communicably connected to said delivery management server through the communications network, is registered;
(b) sender information obtaining means for obtaining sender information from an individual electronic message addressed to the user;
(c) checking means for checking as to whether or not said sender information, which has been obtained by said sender information obtaining means, of the last-named individual electronic message is identical with said permitted-sender information registered in said permitted-sender list;
(d) delivering means for delivering said last-named electronic message, which contains said last-named sender information registered in said permitted-sender list, to the user if the result of the checking by said checking means is positive;
(e) a message holder for temporarily holding every electronic message from any sender so as to be browsed by the user from the terminal;
(f) storing control means for storing the last-named electronic message into said message holder if the result of the checking by said checking means is negative;
(g) browsing control means for allowing the individual electronic messages, which have been temporarily held in said message holder, to be browsed by the user from the terminal upon a browsing request of the user from the terminal;
(h) link setting means for setting a link between said sender information of an individual electronic message, which has been temporarily held in said message holder, and said permitted-sender list while the user is browsing the last-named individual electronic message from the terminal; and
(i) registering means for registering said sender information of an electronic message in said permitted-sender list when the sender of the last-named electronic message is selected as a newly permitted sender by the user from the terminal.

11. An electronic message delivery management server according to claim 10, further comprising notifying means for notifying the user that an electronic message has been held in said message holder, if said message holder holds the last-named electronic message therein.

12. An electronic message delivery management server according to claim 11, wherein said notifying means performs the notification of said last-named electronic message held in said message holder, at predetermined time intervals.

13. An electronic message delivery management server according to claim 10, wherein said electronic message is an e-mail.

14. An electronic message delivery management server according to claim 11, wherein said electronic message is an e-mail.

15. An electronic message delivery management server according to claim 12, wherein said electronic message is an e-mail.

16. An electronic message delivery system according to claim 10, wherein said electronic message is a voice mail.

17. An electronic message delivery system according to claim 11, wherein said electronic message is a voice mail.

18. An electronic message delivery system according to claim 12, wherein said electronic message is a voice mail.

19. A recording medium in which an electronic message delivery management program for a computer to manage the delivering of electronic messages, electronically sent out on a communications network and addressed to a user, is recorded, wherein said program instructs the computer to function as the following:
(a) sender information obtaining means for obtaining sender information from an individual electronic message addressed to the user;
(b) checking means for checking as to whether or not said sender information, which has been obtained by said sender information obtaining means, of the last-named individual electronic message is identical with permitted-sender information registered in a permitted-sender list by the user from a terminal on the communications network, said permitted-sender information being information about a permitted sender, whose every electronic message is permitted to be received by the user on the terminal;
(c) delivering means for delivering said last-named electronic message, which contains said last-named sender information registered in said permitted-sender list, to the user if the result of the checking by said checking means is positive;
(d) storing control means for temporarily storing, into a message holder, every electronic message from any sender so as to be browsed by the user from the terminal if the result of the checking by said checking means is negative;
(e) browsing control means for allowing the individual electronic messages, which have been temporarily held in said message holder, to be browsed by the user from the terminal upon a browsing request of the user from the terminal;
(f) link setting means for setting a link between said sender information of an individual electronic message, which has been temporarily held in said message holder, and said permitted-sender list while the user is browsing the last-named individual electronic message from the terminal; and
(g) registering means for registering said sender information of an electronic message in said permitted-sender list when the sender of the last-named electronic message is selected as a newly permitted sender by the user from the terminal.

20. A recording medium according to claim 19, wherein said program further instructs the computer to function as notifying means for notifying the user that an electronic message has been held in said message holder, if said message holder holds the last-named electronic message therein.

21. A recording medium according to claim 20, wherein said program instructs the computer to function as said notifying means in such a manner that said notifying means performs the notification of said last-named electronic message held in said message holder, at predetermined time internals.
